(19) United States
(12) Patent Application Publication
(10) Pub. No.: US 2007/0245613 A1
(43) Pub. Date: Oct. 25, 2007

(54) Image display device with permanently incorporated pins

(76) Inventor: Matthew Vhay Williams, Grand Blanc, MI (US)

Correspondence Address: Matthew V. Williams, 12767 Grace Court, Grand Blanc, MI, 48439, US

(21) Appl. No.: 11/385,299

(22) Filed: Mar. 21, 2006

(51) Int. Cl. G09F 3/12

(52) U.S. Cl. 40/668

(57) ABSTRACT

An image display device comprises a frame (40) with permanently attached pins (56) protruding from a back face (54). The frame (40) holds an image (42) comprising a photo, artwork, etc. The protruding pins (56) enable the frame (40) to be easily affixed to an office partition wall (44). The pins (56) may either form one integral piece with the material of the frame (40) or be attached with an adhesive (66) to the back face (54) or border (68) of the frame (40).

### BACKGROUND

1. Field of the Invention

This invention relates to image display devices such as picture frames, specifically to image display devices that are suitable for attachment to office partition panels.

2. Prior Art

Cubicle partitions have long been the norm for providing a modicum of privacy while maximizing efficiency in the use of office space. In their use of office cubicles, office workers use much of the limited space assigned them for items directly pertinent to their various tasks.

Almost universally, however, office workers keep images of loved ones and other personal images around them to personalize their otherwise functional surroundings. The most common approach to this end is to place standing picture frames on the desk surface. Such an approach limits available functional desk space, however. Pictures often vie for room with task-related desk items.

Office partition walls provide the largest alternative space available. These walls are often characterized by surfaces such as cloth-covered Styrofoam that lend themselves to the mounting of articles with pins, such as papers and calendars. Unlike desk space, this frequently extensive wall space tends to be largely free of work-related objects.

The most straightforward method of affixing a paper image (picture or clipping) to a partition wall is simply to pin the image to the wall as one would other, work-related papers. This method leaves the image permanently damaged, however. Thus, multiple efforts have been made to provide a method for mounting an image frame with pins or pin-like elements to a partition wall without damaging the image.

Separate, Attachable Frame-Hanging Devices

Some of these efforts have involved separate pin devices that can be attached to picture frames of varying types or other objects unrelated to image display. Such devices include those shown in U.S. Pat. No. 5,269,485 (Dwinell et al; Dec. 14, 1993), U.S. Pat. No. 6,315,254 (Maloney, Nov. 13, 2001), U.S. Pat. No. 6,325,345 (Carpenter, Dec. 4, 2001), U.S. Pat. No. 6,471,169 (Maloney, Oct. 29, 2002), and U.S. Pat. No. 6,923,411 (Chen et al; Aug. 2, 2005). The disadvantage common to these devices derives from the limited weight tolerance of office partition walls, which are generally composed of low-density material. Any frame attached to the above devices must be tested to ensure that its weight does not exceed the tolerance of the wall. This testing process consumes time, which is precious in an office environment. In Dwinell et al, Maloney, '254, and Maloney, '169, the use of non-permanent adhesive to attach the frame or other object to the separate hanging device increases weight sensitivity.

Within the crowded art of picture hanging in general one likewise finds separate devices with pins designed to be attached by various means to frames of varying types and to sustain them on a wall. Such devices are shown in U.S. Pat. No. 1,752,297 (Gillette, Apr. 1, 1930), U.S. Pat. No. 2,742,250 (Cronberger, Mar. 26, 1952), and U.S. Pat. No. 5,464,185 (Hensley, Nov. 7, 1995). The chief disadvantage of applying these devices to the office environment is the assembly time they require. All of these devices comprise multiple elements. One must carefully attach each element individually to ensure proper mounting on the wall. The time required can be significant, particularly if numerous frames are to be mounted.

Thus, the chief disadvantages inherent in all these separate and attachable pin devices are the following:

(a) Cubicle walls tolerate a limited amount of weight. Frames must be tested to determine whether or not the wall will sustain their weight. This process consumes the office worker's precious time.

(b) The assembly effort required to mount separate pin devices to image frames likewise consumes time. This time consumption is exacerbated if numerous frames are to be mounted.

Complex Combinations of Pins and Image Frames

Attempts have likewise been made to incorporate pins integrally into image display devices. These attempts are generally characterized by the inclusion of complex elements such as flanges, hinges, male-female portions, additional fasteners, etc. U.S. Pat. No. 6,439,520 (Johnson, Aug. 27, 2002) and U.S. Pat. No. 6,484,996 (Astell, Nov. 26, 2002) represent efforts directed specifically at surfaces such as office partition walls and corkboard. U.S. Pat. No. 5,249,765 (Garcia, Oct. 5, 1993) and U.S. Pat. No. 2,127,078 (Zwicker, Aug. 16, 1938) are aimed at image display in general. The level of complexity and the plurality of interacting parts shown in these patents are unnecessary in a frame to be mounted to an office partition wall. Such complexity translates into extra cost of manufacture.

Analogous complexity is found in the device of U.S. Pat. No. 1,079,617 (Tennie, Nov. 25, 1913). Tennie's device incorporates laterally oriented spearhead-shaped prongs in addition to laterally oriented tongues. The prongs and tongues must be bent into place to function properly. In addition to requiring the extra step of bending, the necessarily flexible nature of the tongues limits the number of usable materials.

The chief common disadvantage of these apparatuses is their complexity, which is unnecessary for the purpose of displaying images on an office partition wail.

Frame Fasteners with Pins on Two Sides

Finally, a number of frame-mounting devices have been created with pins on both the front and back sides. A pin on the front side of the device attaches to the back side of the frame, and a pin on the back side of the device attaches to the wall. Thus, each device is designed to be used to attach a frame to a wall. Such devices are shown in U.S. Pat. No. 1,023,502 (Callanan, Apr. 16, 1912), U.S. Pat. No. 1,297,584 (Mock, Mar. 18, 1919), U.S. Pat. No. 1,314,548 (Taylor, Sep. 2, 1919), U.S. Pat. No. 1,675,282 (Strand, Nov. 10, 1926), U.S. Pat. No. 5,328,139 (Barnes, Jul. 12, 1994), and U.S. Pat. No. 5,588,629 (Barnes, Dec. 31, 1996).

These devices share the disadvantages common to all separate, attachable mounting devices cited above. An additional disadvantage of these devices is that they can be used only with frame materials that lend themselves to easy puncture, such as wood. They cannot be used with frames made wholly from lightweight hard plastic, for example.

3. Advantages

Accordingly, several advantages of some aspects of the present image display device are:

(a) to provide an improved image display mounting device;

(b) to provide an improved image display device where weight testing prior to mounting on an office partition wall is not necessary;

(c) to provide an image display device where no assembly is required prior to mounting, other than insertion of an image into the device;

(d) to provide an image display device with simple pin fasteners, comprised of minimum elements required for mounting; and

(e) to provide an image display device that can be manufactured from a wide array of materials, including lightweight plastic.

Further advantages of various aspects of the present image display device, deriving from the above advantages, are:

(a) to provide an image display device that is cost-effective to manufacture given the simplicity of its elements; and

(b) to provide an image display device whose operation is extremely simple.

Still further advantages will become apparent from a consideration of the ensuing description and drawings.

### SUMMARY

In accordance with the invention, an image display device comprises a frame for holding an image, such as a picture or clipping. The frame has a front face, a back face, an opening for image insertion, and one or more pins. The pins are permanently attached to the back face of the frame. The device is primarily used for mounting an image simply and easily on an office partition wall, though it may be used for mounting an image on any wall made from low-density material where pins may easily be inserted.

### DRAWINGS—FIGURES

FIG. 1 is a perspective view of a prior-art image display device that includes a magnetic interface to allow detachment of pin fasteners.

FIG. 2 is a perspective view of an image display device with pins integral with the device's back face in accordance with the invention.

FIG. 3 is a perspective view of an image display device with pins permanently adhered to the back face in accordance with the invention.

FIG. 4 is a perspective view of an image display device with a discrete border portion, with pins permanently adhered to the back face in accordance with the invention.

FIG. 5 is a perspective view of an image display device with a discrete border portion, with pins permanently adhered to the border in accordance with the invention.

FIG. 6 is a perspective view of an image display device with a discrete border portion, with pins integral with the back face in accordance with the invention.

FIG. 7 is a perspective view of an image display device with a discrete border portion, with pins integral with the border in accordance with the invention.

FIG. 8 is a perspective view of an image display device with pins secured in place by a thin sheet adhered to the back face in accordance with the invention.

### DRAWINGS—REFERENCE NUMERALS

| | |
|---|---|
| 10 | Image display device (frame) |
| 12 | Image |
| 14 | Corkboard |
| 18 | Opening for image insertion |
| 20 | Front face |
| 22 | Bent or bight portion |
| 24 | Back face |
| 26 | Pin |
| 28 | Pin tip |
| 30 | Pin head |
| 32 | Fixed magnetic backing |
| 34 | Removable magnetic interface |
| 40, 40A | Image display device (frame) |
| 42 | Image |
| 44 | Office partition wall |
| 48, 48A | Opening for image insertion |
| 50, 50A | Front face |
| 52 | Bent or bight portion |
| 54, 54A | Back face |
| 56 | Integral pin |
| 58 | Adhered pin |
| 60 | Integral pin tip |
| 62 | Adhered pin tip |
| 64 | Adhered pin head |
| 66 | Adhesive |
| 67 | Center portion of frame |
| 68 | Border portion of frame |
| 70 | Thin sheet |

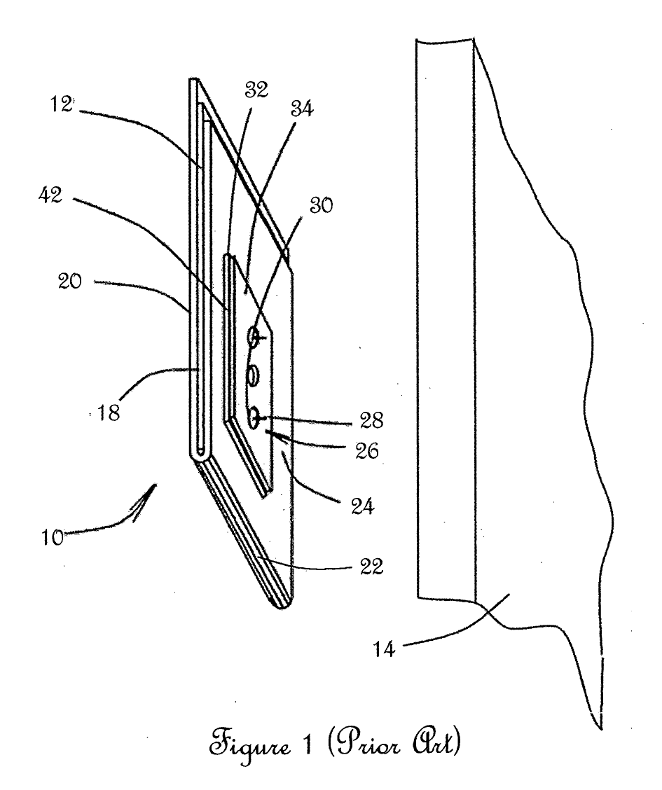

### DETAILED DESCRIPTION—PRIOR ART—FIG. 1

A prior-art image display device or frame 10 is illustrated in FIG. 1. Device 10 holds and displays an image 12 such as a photo (only edge is viewable). Device 10 is mounted on a surface made from corkboard 14 so that it displays or holds image 12 on corkboard 14. The device includes an opening 18 for inserting image 12. Frame 10 has parallel front and back faces 20 and 24, respectively, which are integrally joined by a bent or bight portion 22. The frame is fastened to corkboard 14 by pins 26, each consisting of a pin tip 28 and a pin head 30.

A fixed magnetically permeable strip or backing 32 is attached to back face 24. A removable magnetically permeable strip or interface 34 forms a magnetic seal with backing 32. In turn, pins 26 are attached to interface 34. In this fashion, pins 26 remain in corkboard 14 when frame 10 is removed by breaking the magnetic seal between interface 34 and backing 32.

This device is designed for surfaces comprising relatively high-density material such as corkboard from which pin removal requires significant effort. The included magnetic backing and magnetic interface enable detachment of the frame without removal of the pins. These magnetic elements lend undesirable complexity to the device.

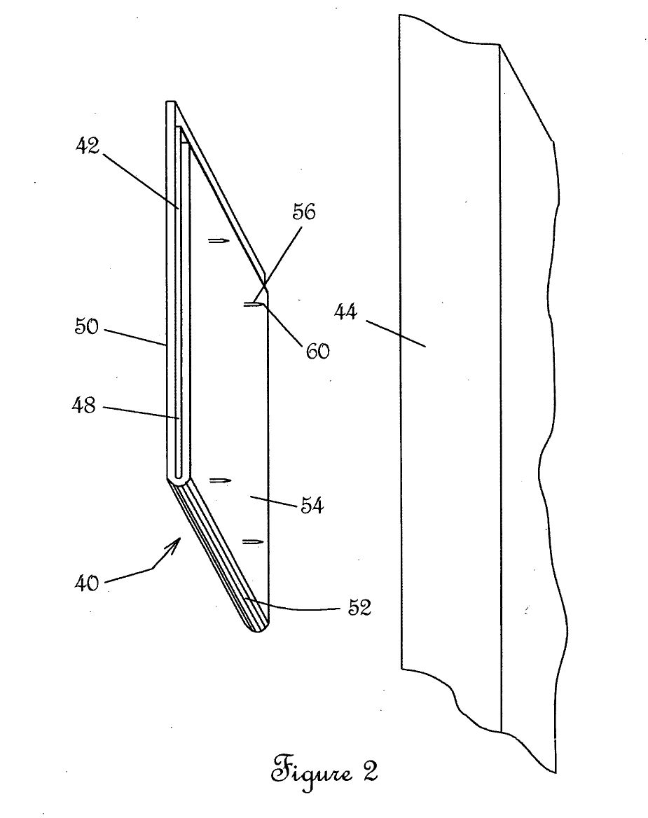

### Description —Preferred Embodiment—FIG. 2

A preferred embodiment of the image display device of the present invention is illustrated in FIG. 2.

An image display device or frame 40 holds and displays an image 42 such as a photo (only edge is viewable) on an office partition wall 44. Device 40 includes an opening 48 for inserting image 42. Frame 40 has parallel front and back faces 50 and 54, respectively, which are integrally joined by a bent or bight portion 52.

Four pins 56 extend from back face 54 perpendicularly and are integral with back face 54. Each pin has a tip 60 for insertion into wall 44. While four pins are shown, more or fewer pins can be used, e.g. from one to eight, depending on the size of the device.

The preferred material for all elements of frame 40 including pins 56 is a molded transparent plastic such as acrylic. The entire device may be made through a single process of pressure injection molding.

The preferred dimensions of the frame are 4″×6″. The pins are preferably of a length and width similar to that of thumbtacks in present use, i.e. approximately ¼″ and 1/32″ respectively. Nonetheless, the frame's dimensions may be different if differently sized images are to be displayed, such as 5″×7″, 8″×10″, etc. Likewise, the pins' length and width may be different depending on the material of the wall to which they are to be attached.

### Operation—Preferred Embodiment—FIG. 2

To mount a photo or other image, image 42 is inserted into opening 48 such that image 42 is fully visible through transparent front face 50, similar to the way images are inserted into devices in present use.

The device is then placed against wall 44 at a desired height such that image 42 is in an upright position, with back face 54 facing wall 44. Device 40 is then pushed into wall 44 with sufficient force for pin tips 60 to pierce wall 44 until pins 56 are fully inserted into the material of wall 44, i.e. until back face 54 contacts wall 44.

The advantage of this device over the prior-art device described in FIG. 1 is a simplification of elements, which decreases cost of manufacture. The device of FIG. 1 requires the addition of a removable magnetic interface for easy detachment from corkboard. In contrast, the present device requires no such interface. Given the relatively low-density material of which office partition walls are often constructed, the present device may easily be fully removed and re-inserted multiple times into such walls without the need for additional elements.

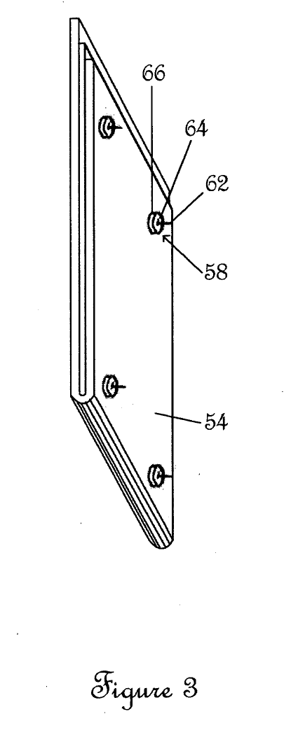

### Alternative Embodiment—FIG. 3—Adhered Pins

A first alternative embodiment is shown in FIG. 3. In this embodiment, pins 58 consisting of a tip 62 and a head 64 are permanently attached to back face 54 with an adhesive 66.

Pins 58 preferably are flat-headed thumbtacks with plastic heads similar to those in present use. Adhesive 66 is preferably hot melt glue.

The operation of this embodiment is identical to and has similar advantages to that of the preferred embodiment.

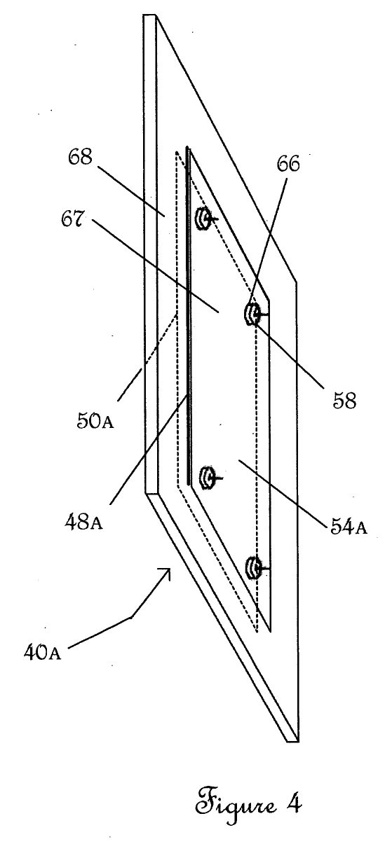

### Alternative Embodiments—FIGS. 4 to 7—Frame with Border

Further alternative embodiments are shown in FIGS. 4, 5, 6, and 7. In these embodiments, frame 40A includes a center portion 67 and a discrete border portion 68. An opening 48A allows an image to be inserted between front face 50A and back face 54A of center portion 67.

Border 68 is preferably made of colored plastic and is preferably adhered to the outer edges of front and back faces 50A and 54A, respectively, with an adhesive such as hot melt glue.

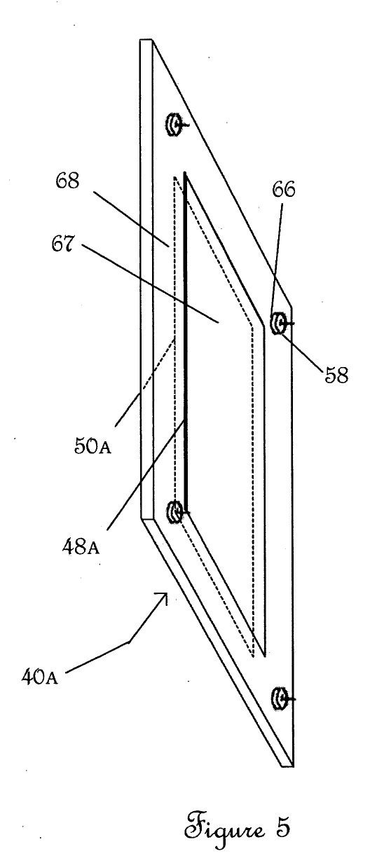

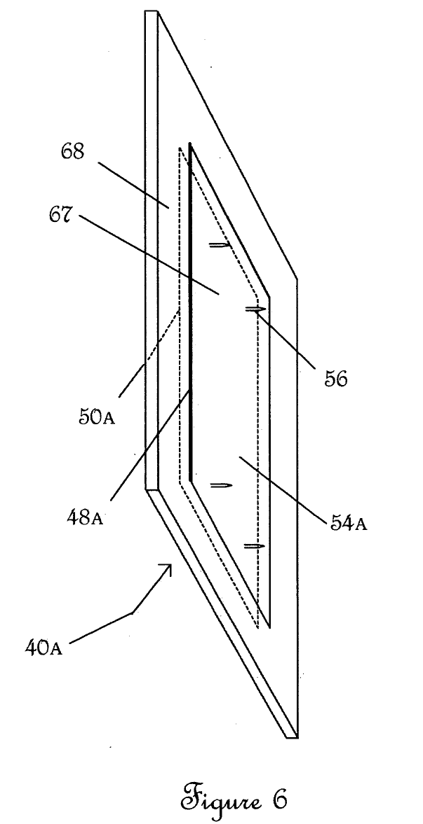

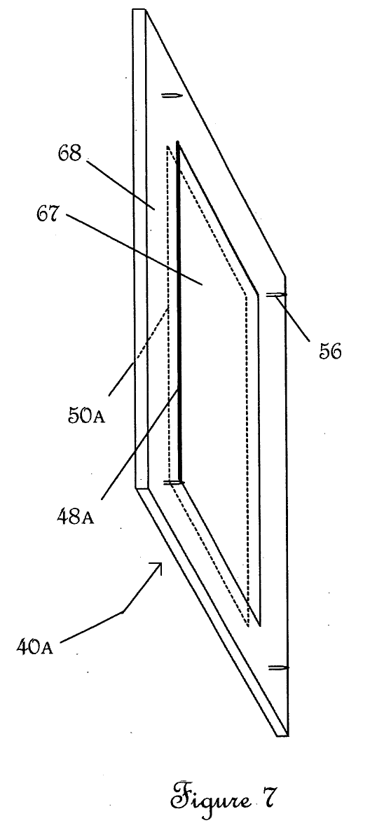

In FIG. 4, pins 58 are permanently attached with adhesive 66 to back face 54A. In FIG. 5, pins 58 are attached with adhesive 66 to border 68. In FIG. 6, pins 56 extend from back face 54A and are integral with back face 54A. In FIG. 7, pins 56 extend from border 68 and are integral with border 68.

The operation of these embodiments is identical to and has similar advantages to that of the preferred embodiment.

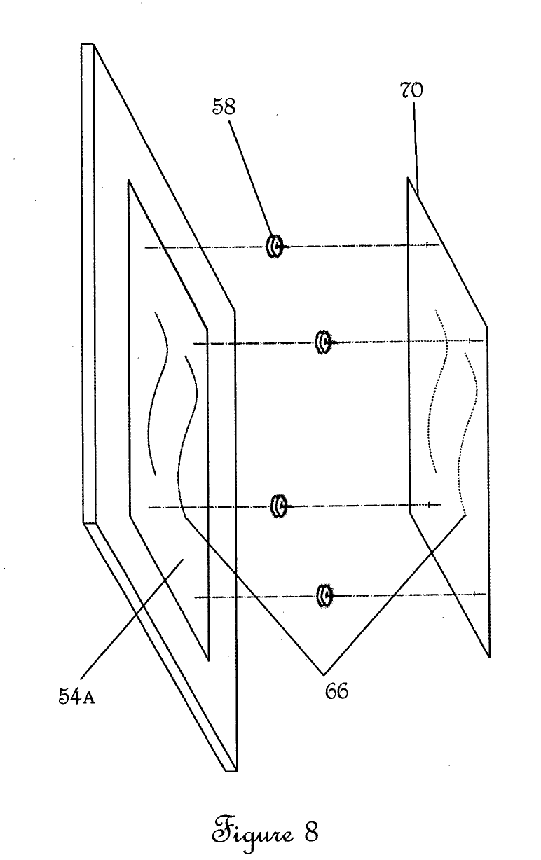

### Alternative Embodiment—FIG. 8—Pins Attached with Thin Sheet

A sixth alternative embodiment is shown in FIG. 8. In this embodiment, pins 58 are permanently secured to back face 54A by the attachment of a thin sheet 70 to back face 54A with adhesive 66 in such a way that pins 58 protrude through thin sheet 70. Sheet 70 is preferably composed of plastic, such as thin transparent polypropylene in present use for laminating. However, thin sheet 70 may also be composed of other materials, such as paper or cardboard.

The operation of this embodiment is identical to and has similar advantages to that of the preferred embodiment.

### Conclusion, Ramifications, and Scope

Thus the reader will see that the image display device of the invention provides a simple, economical means for displaying images (photos, artwork, articles, clippings, etc.) within an office environment without using the limited space available on a desk and without mutilating the images. Advantages include:
No need for weight testing before mounting—frame is designed for mounting on office partition walls;
No frame-to-fastener assembly required prior to mounting;
Maximum simplicity of component elements;
Versatility of design allowing for manufacture from varying materials, including lightweight plastic;
Cost-effective manufacture due to the simplicity of the component elements; and
Maximum simplicity of operation—just place and press.

While the above description contains many specificities, these should not be construed as limitations on the scope of the invention, but rather as exemplifications of the presently preferred embodiments thereof. Many other variations are possible within the teachings of the invention. For example:
The pins may be of any number from one to ten or more—when one pin is used, it preferably is mounted near the top of the device, in the horizontal center;
The pins may be positioned at an acute angle to the back face or border of the device;
The pins may be larger or smaller;
The pins may vary in shape and materials, including plastics, wood, and metal;
The device itself may be larger or smaller;
The device and its components may be made of any number of available materials, including wood, metal, cardboard, paper, etc.;
The frame may be made of multiple components of different materials;
In the embodiments including a border, the image may be inserted between the front face and the back face from any angle and in any number of ways, including through displacement of the front or back face;
The frame border may be attached to the front and back face of the device by different means;
The device may be of a different shape, such as square, circular, oval, triangular, trapezoidal, etc.

Thus the scope of the invention should be determined by the appended claims and their legal equivalents, and not by the examples given.

1. An image display device comprising:
a) a frame for holding a sheet of material displaying an image;
b) at least one pin protruding from a back face of said frame, said pin being of the same material of said back face and being integral with said back face.

2. The image display device of claim 1 wherein said frame is a single piece of translucent plastic.

3. The image display device of claim 1 wherein said frame comprises multiple pieces of different materials.

4. The image display device of claim 1 wherein said frame comprises a center portion and a discrete border portion.

5. The image display device of claim 4 wherein said pin protrudes from the back of said border portion.

6. The image display device of claim 5 wherein said border portion is a plastic material.

7. The image display device of claim 5 wherein said border portion is a metallic material.

8. The image display device of claim 1 wherein a plurality of pins protrude from said back face, said pins being of the same material of said back face and being integral with said back face.

9. An image display device comprising:
a) a frame;
b) at least one pin protruding from a back face of said frame, said pin being attached to said frame with an adhesive.

10. The image display device of claim 9 wherein said pin is in the form of a thumbtack.

11. The image display device of claim 9 wherein said frame comprises a center portion and a discrete border portion.

12. The image display device of claim 11 wherein said pin is attached with said adhesive to said border portion.

13. The image display device of claim 9, further including a thin sheet overlaying said pin and attached with said adhesive to said frame, such that said pin protrudes through said thin sheet.

14. The image display device of claim 13 wherein said thin sheet is composed of plastic.

15. The image display device of claim 13 wherein said thin sheet is composed of paper.

16. The image display device of claim 13 wherein said thin sheet is composed of cardboard.

17. The image display device of claim 9 wherein a plurality of pins protrude from said back face, said pins being of the same material of said back face and being integral with said back face.

18. An image display device comprising:
a) a frame for holding a sheet of material displaying an image;
b) at least one pin protruding from a back face of said frame, said pin being permanently attached to said back face.

19. The image display device of claim 18 wherein said pin is attached to said back face with an adhesive.

20. The image display device of claim 18 wherein said pin is integral with and of the same material as said frame.
